(19) United States
(12) Patent Application Publication
(10) Pub. No.: US 2002/0196235 A1
(43) Pub. Date: Dec. 26, 2002

(54) Optical mouse

(76) Inventors: Yen-Liang Kuan, Jia Yi City (TW); Chih-Wen Su, Chung Ho City (TW); Ching-Hsiang Chang, Ban Qiao City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 09/886,152

(22) Filed: Jun. 22, 2001

(51) Int. Cl. G09G 5/08

(52) U.S. Cl. 345/166

(57) ABSTRACT

The invention relates to an optical mouse, comprising a base unit, a transmitter and a receptor installed in the base unit to obtain coordinates, a transparent or semi-transparent sensing board that is installed above the transmitter and the receptor, and an accommodating chamber to accommodate the sensing board. The sensing board is capable of movement, front and back, left and right, inside the accommodating chamber, so designed that the signals transmitted from the transmitter are reflected by the sensing board back to the receptor to measure its coordinates. Then, whenever there is any movement of the sensing board, the change of movement is calculated to indicate the movement of cursor, so that the optical mouse can be used to move the cursor.

### BACKGROUND OF THE INVENTION

1. Field of the Invention

The present invention relates to an optical mouse, particularly to a mouse comprising a sensing board, which is measured by optical means, so that the optical mouse can be used to move the cursor.

2. Background of the Invention

Generally, a mouse is used to control the position of cursor on the monitor screen. In other words, a ball is installed at the bottom of the mouse. The ball moving along with the mouse will activate the sensor inside the mouse to drive the cursor to move. Another control mode involves a touch pad to receive the user's movement on the touch pad, while the theory of electrical induction is employed to detect the measure of movement, and drive the cursor to change its position.

The precision of the touch pad itself and its durability have always been troubling users. Furthermore, the production cost of the touch pad is higher. Also, the touch pad can easily be damaged by accidental force applied onto it. Such disadvantageous factors prevent the touch pad to fully develop its application performance. The mouse is an external appliance that involves production and assembly procedures. Especially, conventional mice with wires do involve the problem of wire connection. Even a wireless mouse will have the problem of contaminated ball, just like the wired mouse.

Basically, the mouse is an essential tool to control the cursor movement on a computer monitor. But all computers are used along with keyboards. If the mouse is an independent component, it will have its inherent problems. But in case the mouse can be installed on the keyboard, there shall be significant contribution to its applicability.

### BRIEF DESCRIPTION OF THE INVENTION

Therefore, the primary objective of this invention is to provide an optical mouse, which comprises a base unit, in the base unit being installed a transmitter and a receptor to obtain the coordinates, a sensing board that is installed above the transmitter and the receptor, and an accommodating chamber to accommodate the sensing board. The sensing board can move front and back and left and right inside the accommodating chamber. The signals transmitted by the transmitter are reflected by the sensing board back to the receptor to measure the coordinates. Whenever there is movement of the sensing board, its movement can be calculated, in order to change the position of the cursor.

The invention of optical mouse can be installed on the keyboard of a desktop computer or a notebook computer, or other appropriate mechanism that requires the installation of moving cursor. As long as a keyboard or the existing circuitry in other mechanism is employed to receive the signals from the optical mouse, in order to control the position and movement of the cursor, this invention of optical mouse can be applied.

### BRIEF DESCRIPTION OF DRAWINGS

The drawings of preferred embodiments of this invention are described in following details to enable fully understanding.

FIG. 1 is a perspective view of the invention of optical mouse showing the optical mouse assembled on a keyboard.

FIG. 2 is a section view showing the relative positions of the transmitter, the receptor and sensing board of the invention of optical mouse.

FIG. 3 is a perspective view of the invention showing the optical mouse assembled on a notebook computer keyboard.

### DETAILED DESCRIPTION OF PREFERRED EMBODIMENTS

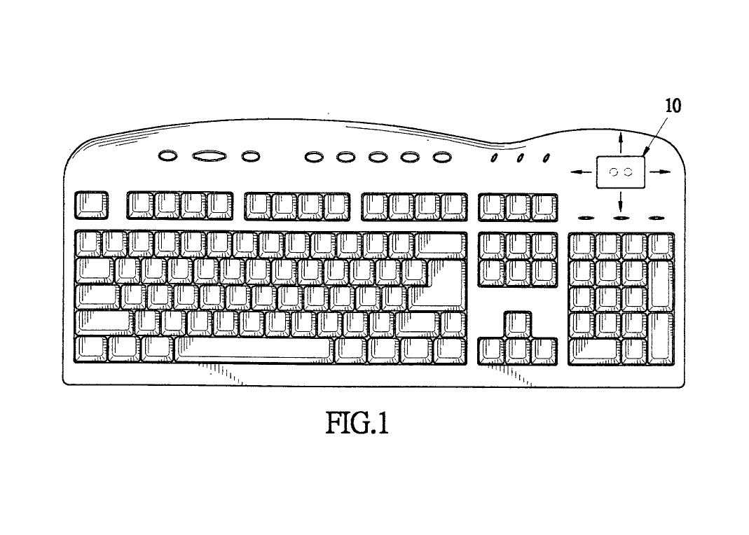

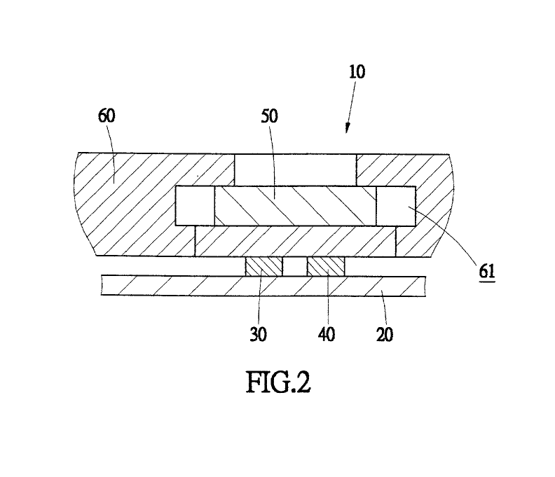

As shown in FIGS. 1 and 2, the invention of optical mouse 10 comprises a base unit 20, a transmitter 30 and a receptor 40 installed in the base unit 20, the transmitter 30 serving to transmit signals and the-receptor 40 serving to receive signals, a sensing board 50 installed above the transmitter 30 and the receptor 40, the sensing board 50 being either a transparent or semi-transparent board, and a casing 60 having an accommodating chamber 61 to accommodate the sensing board 50, the sensing board 50 being able to move, to and fro, left and right, within the accommodating chamber 61.

When the signals transmitted from the transmitter 30 are reflected by the sensing board 50 back to the receptor 40, a set of coordinates can be obtained. Any movement of the sensing board 50 will enable the transmitter 30 and the receptor 40 to obtain another set of coordinates, which are then calculated to know the measure of dislocation based on which the movement of the cursor can be moved, so that the optical mouse will serve as a tool to move the cursor.

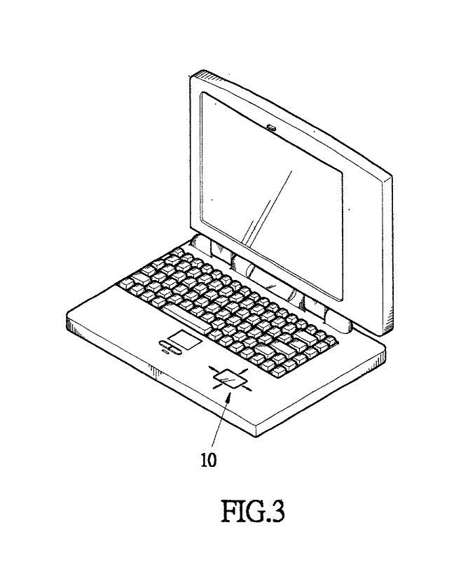

As shown in FIG. 3, this invention of optical mouse can also be installed on the keyboard of a notebook computer. Either a desktop computer or a notebook computer has a keyboard. In the keyboard is relative circuit designs that will feed the digital information obtained by the optical mouse to the computer main unit, to achieve the purpose of moving the cursor.

Similarly, besides personal computer, the cursor is used for operation in other industrial computer, personal digital assistant, electronic book, and such electronic appliances; therefore, this invention of optical mouse can also be applied to such products.

What is claimed is:

1. An optical mouse, comprising a base unit, inside the base unit being installed a transmitter and a receptor installed in the base unit, a sensing board installed above the transmitter and the receptor, and a casing having an accommodating chamber to accommodate the sensing board, the sensing board being able to move to and fro and left and right inside the accommodating chamber;
when the signals transmitted by the transmitter are reflected by the sensing board back to the receptor, a set of coordinates can be measured, and when there is any movement of the sensing board, the transmitter and the receptor can measure another set of coordinates, which are calculated to obtain the measure of movement, which is then based to drive the movement of the cursor, thereby the cursor can be moved by the optical mouse.

2. The optical mouse as claimed in claim 1, wherein said sensing board is a transparent board.

3. The optical mouse as claimed in claim 1, where in said sensing board is a semi-transparent board.
